(19) United States
(12) Patent Application Publication
(10) Pub. No.: US 2026/0045430 A1
(43) Pub. Date: Feb. 12, 2026

(54) ROTARY ELECTRIC COMPONENT

(71) Applicant: ALPS ALPINE CO., LTD., Tokyo (JP)

(72) Inventors: Hiroshi MURAKAMI, Miyagi (JP); Katsuya SAIJO, Miyagi (JP)

(21) Appl. No.: 19/279,410

(22) Filed: Jul. 24, 2025

(30) Foreign Application Priority Data
Aug. 9, 2024 (JP) 2024-134455

(51) Int. Cl. H01H 19/14; H01H 19/04; H01H 19/20

(52) U.S. Cl. CPC H01H 19/14; H01H 19/04; H01H 19/20

(57) ABSTRACT

A rotary electric component includes: a lower casing; an upper cover; a housing; a rotary member rotatably supported relative to the housing; a cam portion including uneven portions continuously formed on the rotary member along an arc-shaped imaginary line; a spring member including a fixed portion sandwiched between the lower casing and the upper cover, an elastic deformation portion extending from the fixed portion, and an elastic contact portion formed on the elastic deformation portion and that comes into contact with the cam portion; a rotation stopper including a latched portion provided on the fixed portion of the spring member and a latching portion provided with the housing and configured to lock the latched portion; and a press-fitting structure including a receiver plate portion and a press-contact plate portion.

### CROSS-REFERENCE TO RELATED APPLICATIONS

The present application is based on and claims priority to Japanese Patent Application No. 2024-134455 filed on Aug. 9, 2024, the entire contents of which are hereby incorporated by reference.

### BACKGROUND

### 1. Field of the Invention

The present disclosure relates to rotary electric components.

### 2. Description of the Related Art

Japanese Laid-Open Patent Application No. 2009-170328 discloses a technique of providing a rotation stopper for holding a click spring between an upper surface of a casing and a mounting metal in a rotary operating encoder provided with an operation shaft capable of being rotated, and stopping the rotation of the click spring by a projection.

### SUMMARY

A rotary electric component according to an embodiment includes: a lower casing including a bottom, a peripheral wall extending upward from a peripheral edge of the bottom, and an opening formed at an upper end of the peripheral wall; an upper cover disposed on an upper side of the lower casing to cover the opening; a housing including the lower casing and the upper cover, and configured to form an accommodation space between the lower casing and the upper cover; a rotary member at least partially accommodated in the accommodation space and rotatably supported relative to the housing with a vertical direction as a center of rotation; a cam portion including uneven portions continuously formed on the rotary member along an arc-shaped imaginary line surrounding the center of rotation; a spring member including a fixed portion sandwiched between the lower casing and the upper cover, an elastic deformation portion extending from the fixed portion, and an elastic contact portion formed on the elastic deformation portion and that comes into contact with the cam portion; a rotation stopper including a latched portion provided on the fixed portion of the spring member and a latching portion provided with the housing and configured to lock the latched portion; and a press-fitting structure including receiver plate portions extending downward from an outer periphery of the upper cover and press-contact plate portions extending from the fixed portion of the spring member toward the receiver plate portions and coming into pressure contact with the receiver plate portions.

### BRIEF DESCRIPTION OF THE DRAWINGS

FIG. 1 is an external perspective view illustrating a rotary electric component according to an embodiment;

FIG. 2 is an exploded perspective view illustrating the rotary electric component according to the embodiment;

FIG. 3 is a perspective sectional view illustrating the rotary electric component according to the embodiment;

FIG. 4 is a perspective sectional view illustrating an engagement state of hooks of the rotary electric component according to the embodiment;

FIG. 5 is a plan view illustrating a lower casing included in the rotary electric component according to the embodiment;

FIG. 6 is a diagram illustrating a rotation stopper and a press-fitting structure included in the rotary electric component according to the embodiment;

FIG. 7 is another diagram illustrating the rotation stopper and the press-fitting structure provided in the rotary electric component according to the embodiment; and

FIG. 8 is a cross-sectional view illustrating the rotary electric component according to the embodiment.

### DETAILED DESCRIPTION OF THE PRESENT DISCLOSURE

In the technique disclosed in Japanese Laid-Open Patent Application No. 2009-170328, stopping the rotation of the click spring is insufficient by the rotation stopper alone. Since the click spring has rattling in a rotation direction, when the operation shaft is rotationally operated, the click spring repeats forward and backward rotation, and noise may be generated from the rotation stopper.

One embodiment will be described in the following with reference to the drawings. In the following description, for convenience, a Z-axis direction in the drawings is a vertical direction, an X-axis direction in the drawings is a forward-backward direction, and a Y-axis direction in the drawings is a right-left direction. Where, a Z-axis positive direction is an upward direction, an X-axis positive direction is a forward direction, and a Y-axis positive direction is a right direction.

### Outline of Rotary Electric Component 100

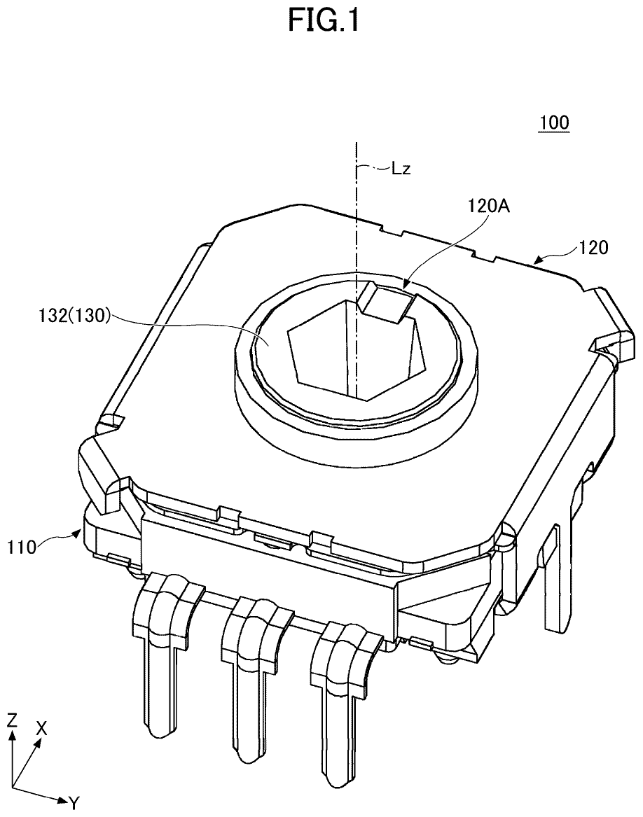

FIG. 1 is an external perspective view illustrating a rotary electric component 100 according to one embodiment. As illustrated in FIG. 1, the rotary electric component 100 is thin in the vertical direction (Z-axis direction) and has a substantially square shape in a plan view from above (Z-axis positive direction). As illustrated in FIG. 1, the housing of the rotary electric component 100 includes a lower casing 110 and an upper cover 120 covering an upper part of the lower casing 110. A circular opening 120A is formed in the center of the upper cover 120. In addition, a rotary member 130 is provided in the lower casing 110 to be rotatable about a rotation center line Lz extending in the vertical direction (Z-axis direction). A rotary shaft portion 132 included in the rotary member 130 projects upward (Z-axis positive direction) from the opening 120A of the upper cover 120. Thus, the rotary electric component 100 can receive a rotational operation to the rotary member 130 by an operator by the rotary shaft portion 132.

### Configuration of Rotary Electric Component 100

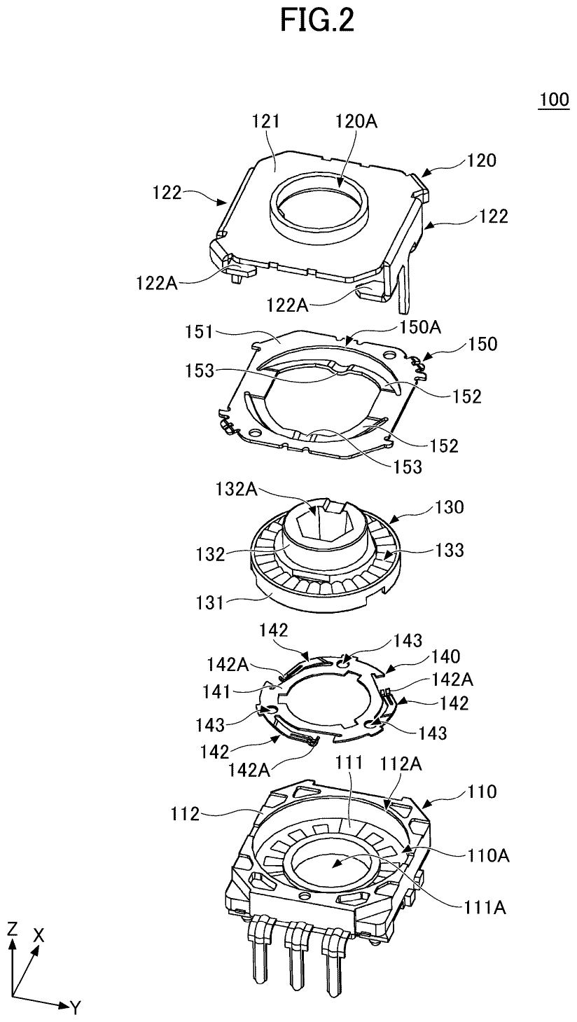

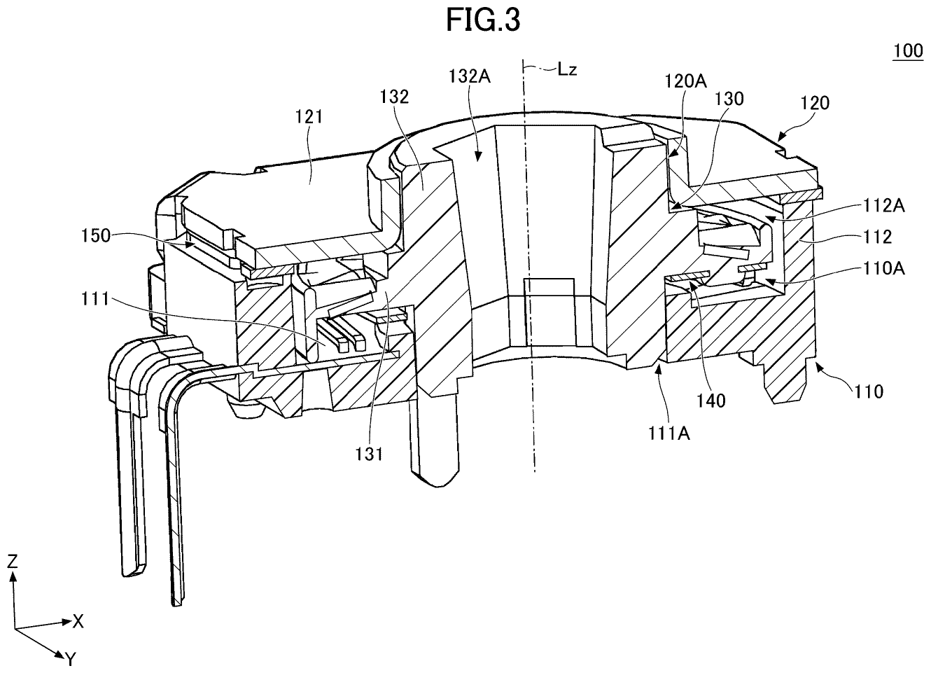

FIG. 2 is an exploded perspective view illustrating the rotary electric component 100 according to the embodiment. FIG. 3 is a perspective sectional view illustrating the rotary electric component 100 according to the embodiment.

As illustrated in FIGS. 2 to 4, the rotary electric component 100 includes the lower casing 110, the upper cover 120, the rotary member 130, a rotary contact member 140, and a spring member 150.

The lower casing 110 is a container-like member having a substantially square shape when viewed from above and having an open upper part. The lower casing 110 includes a horizontal flat-plate bottom 111 and a peripheral wall 112. The peripheral wall 112 extends upward (in the Z-axis positive direction) from the peripheral edge of the bottom 111 so as to surround the rotation center line Lz passing through the center of the bottom 111, and forms an accommodation space 110A inside. The accommodation space 110A accommodates the rotary member 130 and the rotary contact member 140. An opening 112A having a circular shape in a plan view from above (in the Z-axis positive direction) is formed at the upper end of the peripheral wall 112. The lower casing 110 is formed by insert molding by using, for example, a relatively hard insulating material (for example, hard resins or the like). A bearing hole 111A having a circular shape when viewed from above and penetrating through the bottom 111 in the vertical direction is formed at the center of the bottom 111.

The upper cover 120 is a horizontal flat-plate member made of metal having a base portion 121 that is substantially square (strictly speaking, an octagonal shape in which each of the four corners is cut diagonally) when viewed from above. The upper cover 120 is fixedly attached to the upper surface of the lower casing 110, thereby covering the opening 112A of the peripheral wall 112 of the lower casing 110 with the base portion 121, and sandwiching the spring member 150 between the base portion 121 and the upper surface of the lower casing 110. In a plan view from above (Z-axis positive direction), a circular opening 120A through which the rotary shaft portion 132 of the rotary member 130 is inserted is formed in the center of the base portion 121 of the upper cover 120. The upper cover 120 is formed, for example, by processing a metal plate by a processing method such as press working.

The rotary member 130 is a member made of a resin that rotates by receiving a rotational operation by an operator. The rotary member 130 is arranged in the accommodation space 110A of the lower casing 110, and is supported relatively rotatably with respect to the lower casing 110, with the rotation center line Lz extending in the vertical direction (Z-axis direction) as the center of rotation.

The rotary member 130 includes the rotary shaft portion 132 in the center, and a base portion 131 around the rotary shaft portion 132. The base portion 131 is a horizontal disk-shaped portion which projects in an outer radial direction from the rotary shaft portion 132. The rotary shaft portion 132 is a cylindrical portion extending from the center of the base portion 131 in the vertical direction (Z-axis direction). The upper portion of the rotary shaft portion 132 penetrates through the opening 120A of the upper cover 120 and projects upward (Z-axis positive direction) from the upper cover 120, such that the rotational operation by an operator can be received.

As illustrated in FIG. 3, the lower portion of the rotary shaft portion 132 is inserted into the bearing hole 111A formed in the center of the bottom 111 of the lower casing 110, such that the rotary member 130 is rotatably supported by the lower casing 110.

A cam portion 133 is formed on the upper surface of the base portion 131 to provide a click feeling in the rotational operation of the rotary member 130. The cam portion 133 includes uneven portions continuously formed on the upper surface of the base portion 131 along an arc-shaped imaginary line surrounding the rotation center line Lz.

In the center of the rotary shaft portion 132, a through hole 132A, which has a hexagonal shape when viewed from above, is formed and penetrates through the rotary shaft portion 132 in the vertical direction (Z-axis direction). Thus, the rotary member 130 can insert a shaft portion (not illustrated) of an operation knob or the like into the through hole 132A.

The rotary contact member 140 is an annular member made of a metal plate. The rotary contact member 140 rotates integrally with the rotary member 130 by being fixed to the lower surface of the base portion 131 of the rotary member 130. The rotary contact member 140 includes a base portion 141 and three contact spring portions 142. The base portion 141 is an annular portion surrounding the rotary shaft portion 132 of the rotary member 130. The three contact spring portions 142 are provided outside the base portion 141 at equal intervals (i.e., at 120 degrees intervals). Each of the three contact spring portions 142 is an elastic arm portion extending integrally from the base portion 141 along the outer periphery of the base portion 141, and is elastically deformable in the vertical direction (Z-axis direction). Each of the three contact spring portions 142 includes a contact portion 142A projecting downward (Z-axis negative direction) from the tip of the contact spring portion 142. The contact portion 142A is in elastic contact with the upper surface of the bottom 111 of the lower casing 110.

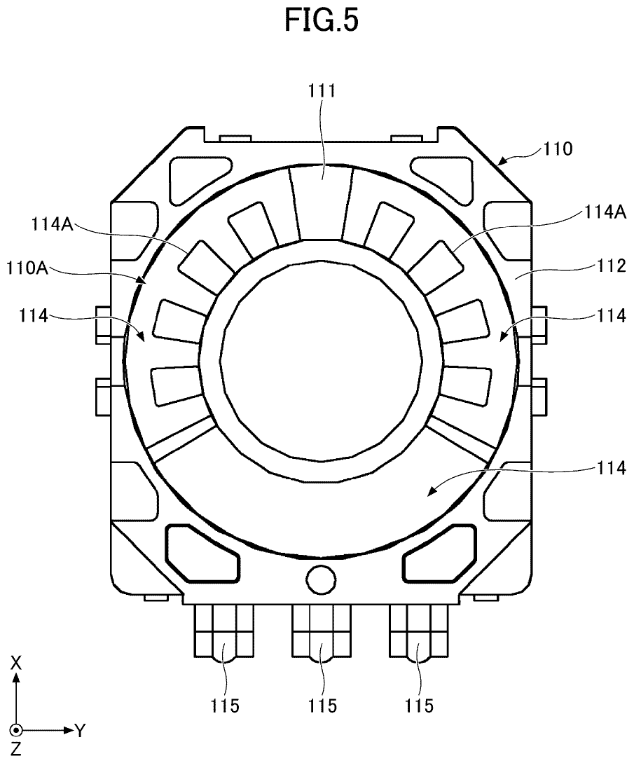

As the rotary contact member 140 rotates integrally with the rotary member 130, an electrical connection state of three fixed contact portions 114 (see FIG. 5) provided on the inner bottom surface (i.e., the top surface of the bottom 111) of the accommodation space 110A of the lower casing 110 is switched via the three contact spring portions 142, such that the rotation direction and a rotation angle of the rotary member 130 can be detected. The base portion 141 of the rotary contact member 140 is provided with three openings 143 at equal intervals in a circumferential direction for fixing the rotary contact member 140 to the lower surface of the base portion 131 of the rotary member 130.

The spring member 150 is a horizontal flat-plate member made of a metal plate and is provided between the upper cover 120 and the lower casing 110. The spring member 150 has an outer shape that is substantially square (strictly speaking, an octagonal shape in which each of the four corners is cut diagonally) when viewed from above (Z-axis positive direction). A substantially circular opening 150A is formed in the center of the spring member 150 when viewed from above (Z-axis positive direction). The spring member 150 includes a fixed portion 151, elastic deformation portions 152, and elastic contact portions 153.

The fixed portion 151 is a frame-like portion formed along the outer periphery of the opening 150A and surrounding the opening 150A. The fixed portion 151 is sandwiched between the base portion 121 of the upper cover 120 and the upper surface of the lower casing 110. The elastic deformation portion 152 extends from the fixed portion 151. Each elastic contact portion 153 is formed at the end of the elastic deformation portion 152 and is in elastic contact with the cam portion 133 of the rotary member 130.

In the spring member 150, the elastic contact portion 153 moves vertically along the cam portion 133 while the elastic deformation portion 152 elastically deforms along with the rotation of the rotary member 130, in a state the elastic contact portion 153 is in elastic contact with the cam portion 133 of the rotary member 130.

At this time, the spring member 150 accelerates the rotation of the rotary member 130 after increasing a rotational load of the rotary member 130 when the elastic contact portion 153 goes over a convex portion of the cam portion 133, and stops the rotation of the rotary member 130 immediately when the elastic contact portion 153 is fitted into a concave portion of the cam portion 133.

Thus, the spring member 150 can provide a click sensation at every predetermined rotation angle with respect to the rotational operation of the rotary member 130.

In the present embodiment, as an example, the spring member 150 includes a pair of elastic deformation portions 152 arranged inside the opening 150A. Each of the pair of elastic deformation portions 152 has a curved shape (substantially a semicircular shape) curved along the inner periphery of the opening 150A, and both ends in each of the elastic deformation portions 152 are connected to the fixed portion 151. The elastic contact portion 153 protruding downward is provided in the middle portion of each elastic deformation portion 152. That is, the spring member 150 includes a pair of elastic contact portions 153, one in the front and the other in the rear of the elastic contact portion 153.

### Engagement State of Hooks 122

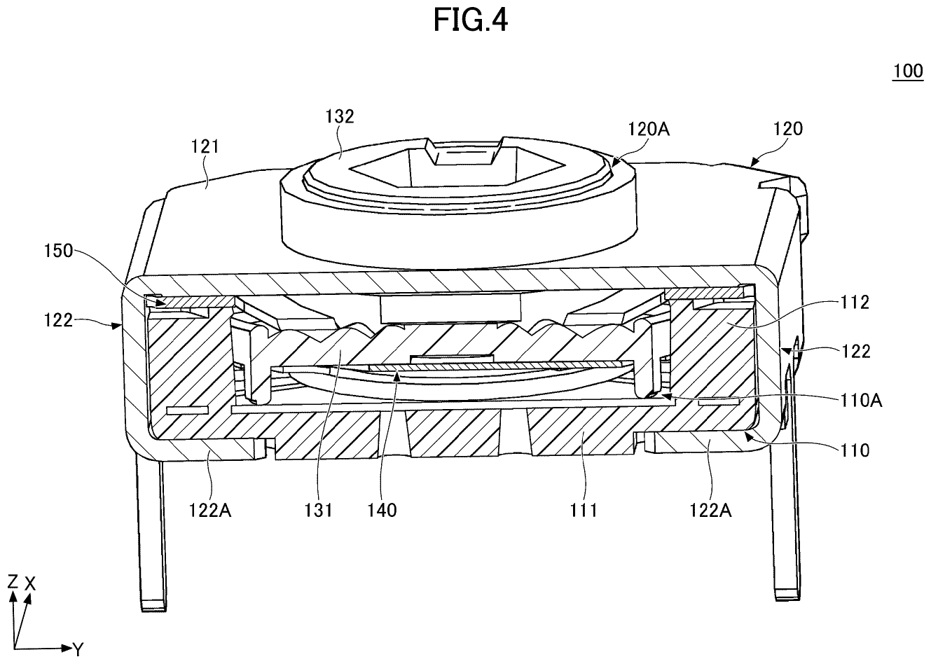

FIG. 4 is a perspective sectional view illustrating an engagement state of hooks 122 of the rotary electric component 100 according to one embodiment.

As illustrated in FIG. 4, the upper cover 120 is provided with hooks 122 hanging downward from each of the left and right edges of the base portion 121. Each hook 122 has a vertical wall shape and is disposed one each outside the left and right sides of the lower casing 110. The hook 122 includes a pair of front and rear claw portions 122A at the lower end of the hook 122. The claw portions 122A are bent at a right angle toward the inside (lower casing 110 side), and are arranged on the lower side (Z-axis negative side) of the lower surface of the lower casing 110.

The upper cover 120 holds the lower casing 110 from both the left and right sides by the pair of left and right hooks 122. The upper cover 120 holds the lower casing 110 from both the upper and lower sides by the base portion 121 and the four claw portions 122A. Thus, the upper cover 120 is fixed to the lower casing 110, and movement (displacement) of the lower casing 110 relative to the upper cover 120 in the forward-backward direction (X-axis direction), the right-left direction (Y-axis direction), and the vertical direction (Z-axis direction) can be restrained.

### Structure of Inner Bottom Surface of the Accommodation Space 110A

FIG. 5 is a plan view illustrating the lower casing 110 included in the rotary electric component 100 according to one embodiment. As illustrated in FIG. 5, on the inner bottom surface of the accommodation space 110A of the lower casing 110 (i.e., the top surface of the bottom 111), three fixed contact portions 114 made of metal plates are arranged on the same circumference in the circumferential direction. Each of the three fixed contact portions 114 has a fan shape so as to form an overall annular shape when viewed from above. The two fixed contact portions 114 of the three fixed contact portions 114 include a plurality of openings 114A (four openings in the example illustrated in FIG. 5) which function as “non-conductive portions” in which the fixed contact portions 114 of the rotary contact member 140 are not conductive, arranged in the circumferential direction.

Each of the three fixed contact portions 114 is connected to corresponding one of three external connection terminals 115 projecting outward from the rear side (X-axis negative side) of the lower casing 110.

The annular rotary contact member 140 is arranged on the upper side of the inner bottom surface of the accommodation space 110A, such that each of the three contact portions 142A of the rotary contact member 140 is brought into elastic contact with the inner bottom surface of the accommodation space 110A. As the rotary contact member 140 rotates, each of the three contact portions 142A slides on the inner bottom surface of the accommodation space 110A in the circumferential direction. In the rotary electric component 100 according to one embodiment, a contact state of the three contact portions 142A with respect to the three fixed contact portions 114 changes as the rotary contact member 140 rotates, and a conduction state of the three fixed contact portions 114 conducted through the rotary contact member 140 changes, such that the rotation direction and the rotation angle of the rotary member 130 can be detected.

### Rotation Stopper and Press-Fitting Structure

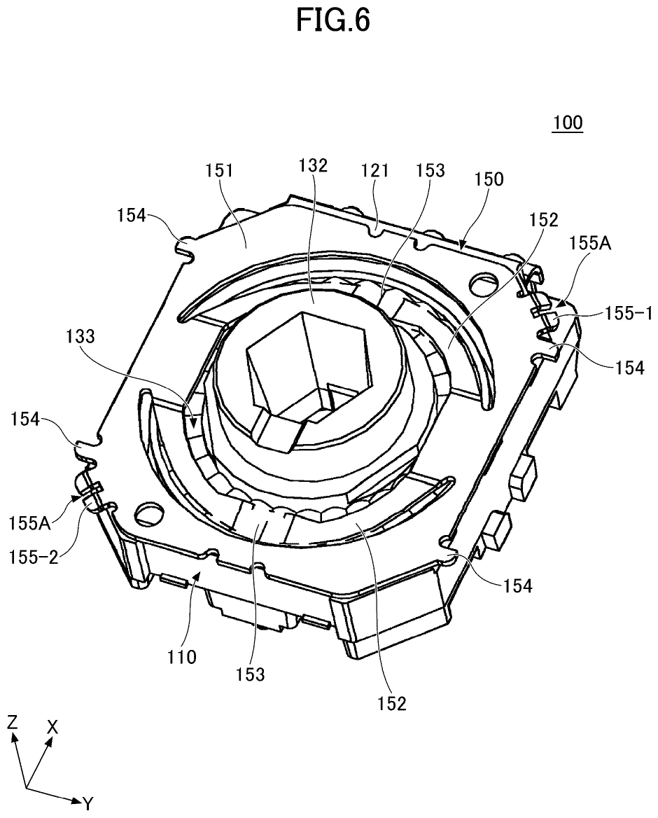

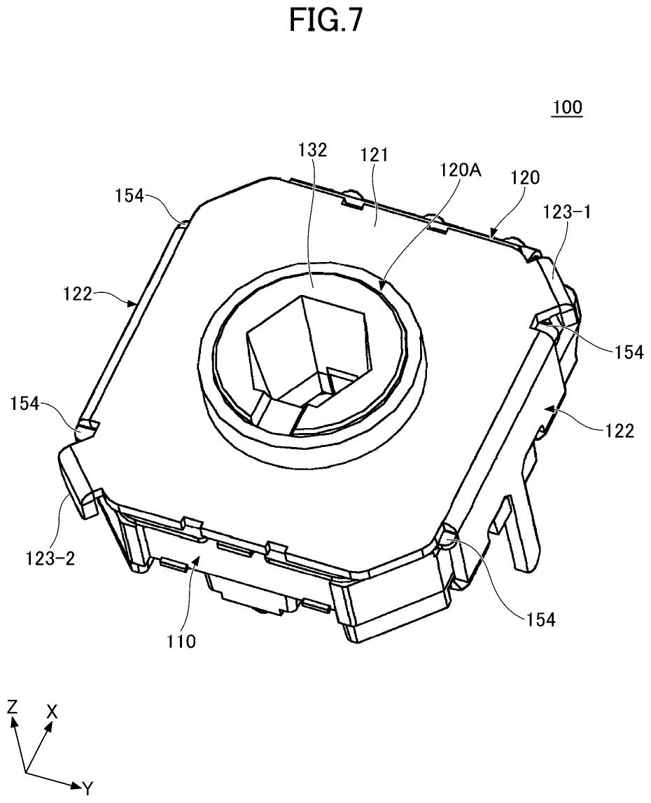

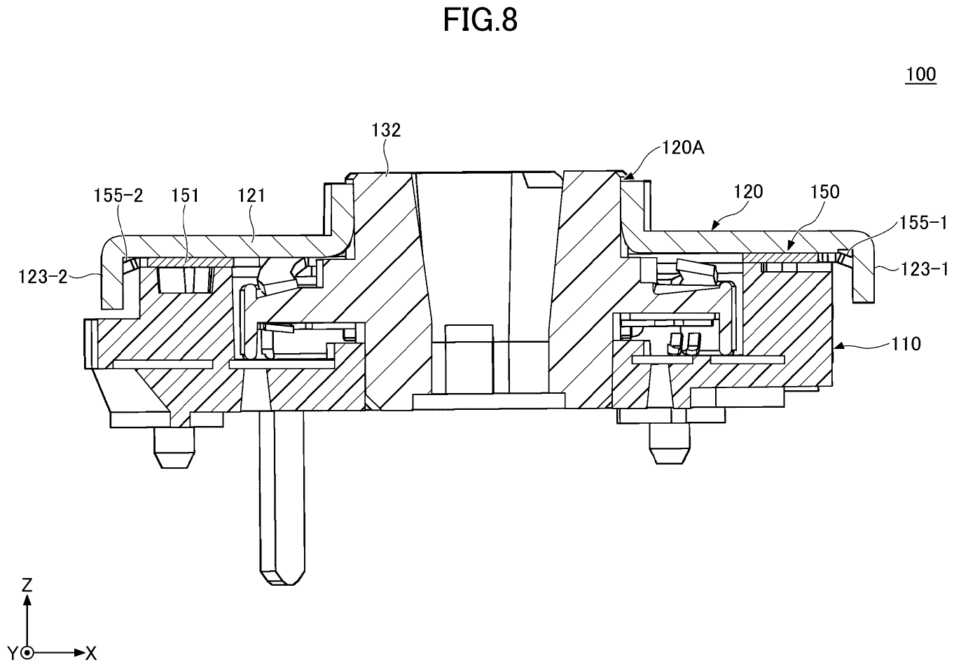

FIGS. 6 and 7 are views for explaining the rotation stopper and press-fitting structure provided in the rotary electric component 100 according to one embodiment. FIG. 6 is a diagram illustrating the rotary electric component 100 in a state where the upper cover 120 is not attached. FIG. 7 is another diagram illustrating the rotary electric component 100 in a state where the upper cover 120 is attached. FIG. 8 is a cross-sectional view illustrating the rotary electric component 100 according to one embodiment.

FIG. 8 illustrates a cross section taken along a cross-sectional line that passes through a first corner and a second corner of the lower casing 110 which will be described in the following.

As illustrated in FIG. 6, the spring member 150 is arranged on the upper surface of the lower casing 110. Here, the spring member 150 includes a pair of claw-shaped latched portions 154 which protrude outward (opposite to the lower casing 110 side) from each of the left and right edges of the fixed portion 151.

As illustrated in FIG. 7, when the upper cover 120 is attached to the lower casing 110, each pair of the left and right hooks 122 of the upper cover 120 is fitted between the pair of latched portions 154 of the spring member 150. Here, the distance between the pair of latched portions 154 is equal to the width of the hook 122 in the forward-backward direction (X-axis direction). Therefore, the hook 122 can be fitted between the front and rear pair of latched portions 154. Therefore, the hook 122 can lock the rotation of the spring member 150 with the rotation center line Lz as the center of rotation by being fitted between the front and rear pair of latched portions 154.

That is, in the present embodiment, the front and rear pair of latched portions 154 provided by the spring member 150 and the hook 122 provided by the upper cover 120 (an example of the “latching portion”) are included in a “rotation stopper” for locking the rotation of the spring member 150.

Also, as illustrated in FIG. 6, the spring member 150 includes a first press-contact plate portion 155-1 and a second press-contact plate portion 155-2, which extend from the outer periphery of the fixed portion 151 toward the outside (a first receiver plate portion 123-1 and a second receiver plate portion 123-2 described in the following).

Specifically, the first press-contact plate portion 155-1 has a tongue piece shape and extends from the right front corner (a corner on an X-axis positive side and a Y-axis positive side) toward the outside (diagonally forward to the right) of the fixed portion 151.

The second press-contact plate portion 155-2 has a tongue piece shape and extends from the left rear corner (a corner on the X-axis negative side and the Y-axis negative side) toward the outside (diagonally backward to the left) of the fixed portion 151.

That is, the first press-contact plate portion 155-1 and the second press-contact plate portion 155-2 are arranged diagonally so as to face each other across the center of rotation (rotation center line Lz).

In contrast to this, as illustrated in FIG. 7, the upper cover 120 includes a first receiver plate portion 123-1 and a second receiver plate portion 123-2, as examples of a “receiver plate portion” which extend downward (Z-axis negative direction) from the outer periphery of the base portion 121.

Specifically, the first receiver plate portion 123-1 has a vertical wall shape and extends downward (Z-axis negative direction) from the right front corner (X-axis positive side and Y-axis positive side corner) on the outer periphery of the base portion 121.

The second receiver plate portion 123-2 has a vertical wall shape and extends downward (Z-axis negative direction) from the left rear corner (X-axis negative side and Y-axis negative side corner) on the outer periphery of the base portion 121.

That is, the first receiver plate portion 123-1 and the second receiver plate portion 123-2 are arranged diagonally so as to face each other across the center of rotation (rotation center line Lz).

As illustrated in FIG. 8, when the upper cover 120 is attached to the lower casing 110, the tip of the first press-contact plate portion 155-1 comes into pressed contact with the inner surface of the first receiver plate portion 123-1, and the tip of the second press-contact plate portion 155-2 comes into pressed contact with the inner surface of the second receiver plate portion 123-2. In this way, the spring member 150 is press-fitted between the first receiver plate portion 123-1 and the second receiver plate portion 123-2.

Thus, the rotary electric component 100 according to one embodiment can suppress rattling of the spring member 150 during rotational operation of the rotary member 130, and therefore, generation of noise caused by the rattling of the spring member 150 can be suppressed.

In addition, in order to allow the tip of the first press-contact plate portion 155-1 to come into pressed contact with the inner surface of the first receiver plate portion 123-1, a radial length of the first press-contact plate portion 155-1 is set such that the position of the tip of the first press-contact plate portion 155-1 is slightly outside in the radial direction of the inner surface of the first receiver plate portion 123-1.

Similarly, in order to allow the tip of the second press-contact plate portion 155-2 to come into pressed contact with the inner surface of the second receiver plate portion 123-2, the radial length of the second press-contact plate portion 155-2 is set such that the position of the tip of the second press-contact plate portion 155-2 is slightly outside in the radial direction of the inner surface of the second receiver plate portion 123-2.

As illustrated in FIGS. 6 and 7, the lower casing 110 has a quadrangular shape including four corners in a top view. The first receiver plate portion 123-1 and the first press-contact plate portion 155-1 are arranged at the first corner (right front corner) of the lower casing 110, and the second receiver plate portion 123-2 and the second press-contact plate portion 155-2 are arranged at the second corner (left rear corner) of the lower casing 110.

Thus, in the rotary electric component 100 according to one embodiment, the spring member 150 can be press-contacted at the first and second corners of the lower casing 110, which are diagonally opposite to each other, such that the rattling of the spring member 150 can be efficiently suppressed when the rotary member 130 is rotationally operated.

As illustrated in FIG. 6, each of the first press-contact plate portion 155-1 and the second press-contact plate portion 155-2 has a split-tip shape with a slit 155A formed at the distal end along the radial direction.

Thus, in the rotary electric component 100 according to one embodiment, each of the first press-contact plate portion 155-1 and the second press-contact plate portion 155-2 can have moderate elasticity, such that the press-contacting stress is not transmitted to the fixed portion 151 via the first press-contact plate portion 155-1 and the second press-contact plate portion 155-2.

In addition, as illustrated in FIGS. 7 and 8, the upper cover 120 is made of metal, and each of the first receiver plate portion 123-1 and the second receiver plate portion 123-2 of the upper cover 120 is formed by bending downward at a right angle at the boundary portion with the base portion 121.

Thus, the rotary electric component 100 according to one embodiment can form the first receiver plate portion 123-1 and the second receiver plate portion 123-2 by performing relatively simple processing on the upper cover 120.

According to the rotary electric component according to the embodiment, the rattling of the spring member can be suppressed when the rotary member is rotationally operated.

Although one embodiment of the present invention has been described in detail above, the present invention is not limited to the embodiment, and various modifications or changes may be made within the scope of the gist of the present invention described in the claims.

For example, in the present embodiment, two sets of press-fitting structures including a “receiver plate portion” and a “press-contact plate portion” are provided, but this is not limited to this, and one set, or three or more sets of press-fitting structures may be provided.

What is claimed is:

1. A rotary electric component, comprising:
a lower casing including a bottom, a peripheral wall extending upward from a peripheral edge of the bottom, and an opening formed at an upper end of the peripheral wall;
an upper cover disposed on an upper side of the lower casing to cover the opening;
a housing including the lower casing and the upper cover, and configured to form an accommodation space between the lower casing and the upper cover;
a rotary member at least partially accommodated in the accommodation space and rotatably supported relative to the housing with a vertical direction as a center of rotation;
a cam portion including uneven portions continuously formed on the rotary member along an arc-shaped imaginary line surrounding the center of rotation;
a spring member including a fixed portion sandwiched between the lower casing and the upper cover, an elastic deformation portion extending from the fixed portion, and an elastic contact portion formed on the elastic deformation portion and that comes into contact with the cam portion;
a rotation stopper including a latched portion provided on the fixed portion of the spring member and a latching portion provided with the housing and configured to lock the latched portion; and
a press-fitting structure including a receiver plate portion extending downward from an outer periphery of the upper cover and a press-contact plate portion extending from the fixed portion of the spring member toward the receiver plate portion and coming into pressed contact with the receiver plate portion.

2. The rotary electric component according to claim 1, wherein
the receiver plate portion includes a first receiver plate portion and a second receiver plate portion that are arranged diagonally so as to face each other across the center of rotation, and
the press-contact plate portion includes a first press-contact plate portion and a second press-contact plate portion, wherein
the first press-contact plate portion comes into pressed contact with the first receiver plate portion, and
the second press-contact plate portion comes into pressed contact with the second receiver plate portion, and
the spring member is press-fitted between the first receiver plate portion and the second receiver plate portion.

3. The rotary electric component according to claim 1, wherein
the lower casing has a quadrangular shape including four corners in a top view, and
the receiver plate portion and the press-contact plate portion are arranged at one corner of the four corners.

4. The rotary electric component according to claim 1, wherein
the press-contact plate portion has a split-tip shape with a slit formed along a radial direction.

5. The rotary electric component according to claim 1, wherein
the upper cover is made of metal, and
the receiver plate portion is formed by bending.
